(19) United States
(12) Patent Application Publication
(10) Pub. No.: US 2003/0020946 A1
(43) Pub. Date: Jan. 30, 2003

(54) Printer capable of directly printing using negative or positive film source

(76) Inventors: Sean M. O'Hara, Lebanon, OR (US); Pieter J. van Zee, Corvallis, OR (US)

Correspondence Address: HEWLETT PACKARD COMPANY, INTELLECTUAL PROPERTY ADMINISTRATION, P O BOX 272400, FORT COLLINS, CO, 80527-2400, US

(21) Appl. No.: 09/916,389

(22) Filed: Jul. 26, 2001

(51) Int. Cl. G06F 15/00; B41J 1/00

(52) U.S. Cl. 358/1.15; 358/1.18

(57) ABSTRACT

The present invention provides methods and printers wherein a printer that may also function as a printer for computer output may also be utilized to provide at least one print from a film. One embodiment of the method of the present invention utilizes the steps of scanning a desired portion of the the printer to provide a digital image and then printing the digital

### FIELD OF THE INVENTION

The present invention relates to printer capabilities, and more particularly to printers capable of printing images directly from negatives.

### BACKGROUND OF THE INVENTION

Various solutions have been utilized in the past for printing from a negative or slide using a computer. Some solutions for printing images from negatives have utilized a computer, a scanner, software to control printing of images, and a printer to allow a person to scan in a negative or a slide and manipulate the image to the required output size and color. When someone simply wants to provide a reprint of an image to a friend, such a complex technique often is a difficult task for the person providing the reprint.

In one example, U.S. Pat. No. 5,894,326 (hereafter '326), describes a system for an electronic camera having a printer. In '326, an optical printer includes, among other elements, an optical printer that is adapted to be optically coupled to a display when in its print position for producing a hard copy output of the subject represented by the display. The logic and control circuitry responds to the display by moving to the print position and de-energizing the display after an image to be printed is selected, and then re-energizing the display when it is in the print position to make hard copies directly optically from the display.

In another instance, set forth in U.S. Pat. No. 6,058,272, a photographic and video image system transforms an image on a frame of a photographic film along with a frame position indicator and aspect information so that film feeding can be controlled and the optical image to video signal transformation operation can be specified. The frame position indicator can be a hole or an optical or magnetic signal and is recorded on the film along with the aspect information. Information may be recorded on the film that describes the user's order for which frames are to be printed and what size of print is desired.

In yet another instance, set forth in U.S. Pat. No. 5,978,609 (hereafter '609), an electronic still video camera has an electro-developing medium and a printer. An optical image is focused and formed on the electro-developing medium by a photographing lens, and is directly recorded and developed thereon as a visible image. The recorded image is photoelectrically read by a charge-coupled device (CCD) image line sensor as a series of pixel data, and the series of pixel data is processed to thereby produce printing data. A printing is then made on paper on the basis of the processed printing data. In '609, a camera is combined with a printer.

In another invention, described in U.S. Pat. No. 5,909,227, a photograph processing and copying system uses coincident force drop-on-demand ink jet printing. A color continuous scanner, a scanner signal conditioning unit, a digital halftoning unit, a data phasing unit and a printing mechanism are used to correct a continuous tone image that is digitally half-toned in real-time and is then printed by a printing head. Thus, the invention describes a high-speed color photograph printing system (mini-lab) that uses a concurrent drop selection and drop separation printing mechanism. In one embodiment, a color, continuous tone scanner that is the width of the color negative transparency is used to scan the image and a printing head is used that is the width of the image to be printed.

Thus, there is a need for a printer that incorporates the ability to insert a photo negative to facilitate low-cost, convenient printing of pictures.

### SUMMARY OF THE INVENTION

The present invention provides methods and printers that provide for printing at least one print from a film using a printer that may also print documents sent from a computer. The method of the present invention provides at least the steps of scanning a desired portion of the film in the printer to provide a digital image and printing the digital image.

### BRIEF DESCRIPTION OF THE DRAWINGS

FIG. 1 is a flow diagram illustrating one embodiment of steps in accordance with the present invention.

FIG. 2 is a flow diagram illustrating another embodiment of steps in accordance with the present invention.

FIG. 3 is a block diagram illustrating one embodiment of a printer in accordance with the present invention.

FIG. 4 is a block diagram illustrating another embodiment of a printer in accordance with the present invention.

### DETAILED DESCRIPTION OF PREFERRED EMBODIMENTS

The present invention provides a method and printer for printing an image directly from a film using a printer that may be coupled to a computer and may also be utilized for printing documents from the computer. Thus, prints may be obtained directly from film utilizing only the printer, facilitating obtaining quick prints or reprints from film.

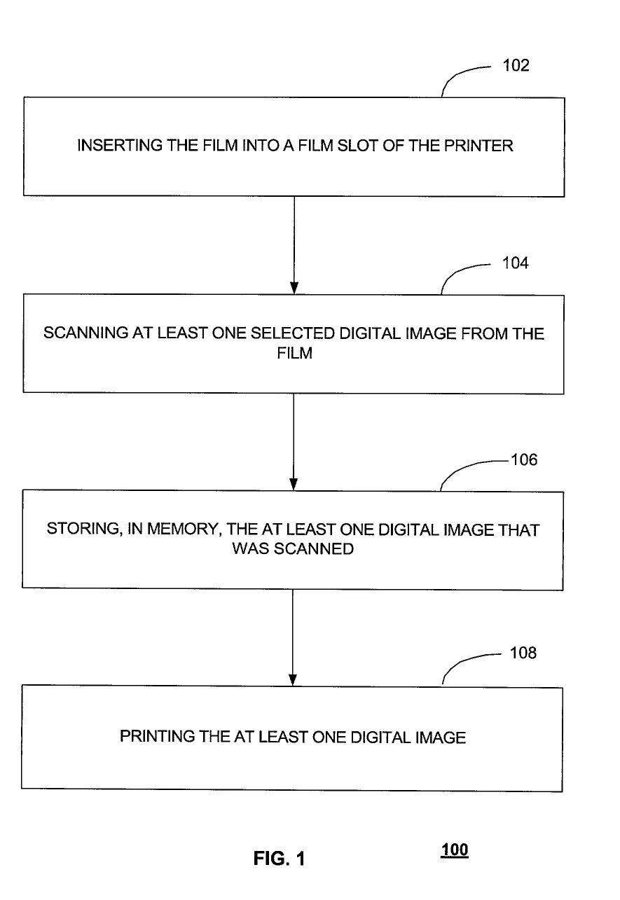

As shown in FIG. 1, numeral 100, the method of the present invention may include the steps of inserting 102 the film into a film slot of the printer, scanning 104 at least one selected digital image from the film, storing 106 the at least one digital image that was scanned in memory and printing 108 the at least one digital image. Where desired, the at least one selected digital image may be selected from a menu of images available on the film. Generally, the menu may include a selection of numbers, each number corresponding to an image on the film such that a desired image of the film that is desired to be printed may be selected. Also, typically the menu provides for selection of a desired number of prints of each selected digital image.

Generally, a plurality of output image sizes may be provided at the printer so that a size of the digital image printed may be selected. There may be a plurality of film slots in the printer so that a user may select a desired size slot for the particular film he is inserting. For example, there may be a slot arranged to accommodate a film strip for 35 mm film and/or a slot arranged to accommodate a slide for 35 mm film. The film may provide for a negative or a positive image to be printed therefrom.

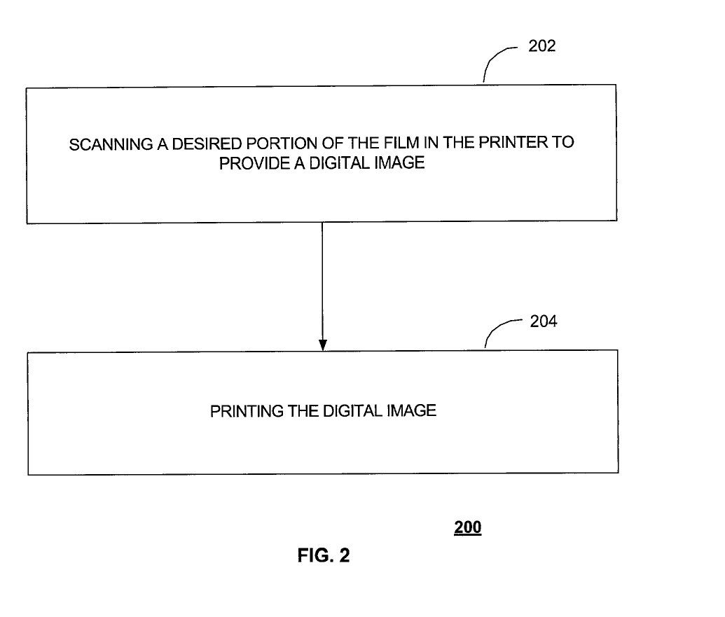

FIG. 2, numeral 200, shows another embodiment of the method of the present invention for using a printer to provide at least one print from a film, where the printer may also function as a printer for a computer. The method includes the steps of scanning 202 a desired portion of the film in the printer to provide a digital image and printing 204 the digital image. That is, the digital image is not stored, but is sent directly to the print mechanism. The digital image for the at least one print is typically selected from a menu of images available on the film. Generally, a designation such as a number or letter may be used to indicate which digital image is desired to be printed. The menu may further include selection of a designation of each digital image of the film that is desired to be printed, including the number of prints desired and the size of the prints.

The film slot may be one of a plurality of film slots, and typically may include a slot arranged to accommodate a film strip for 35 mm film and/or a slot arranged to accommodate a slide for 35 mm film. The film may provide positive or negative images, as desired.

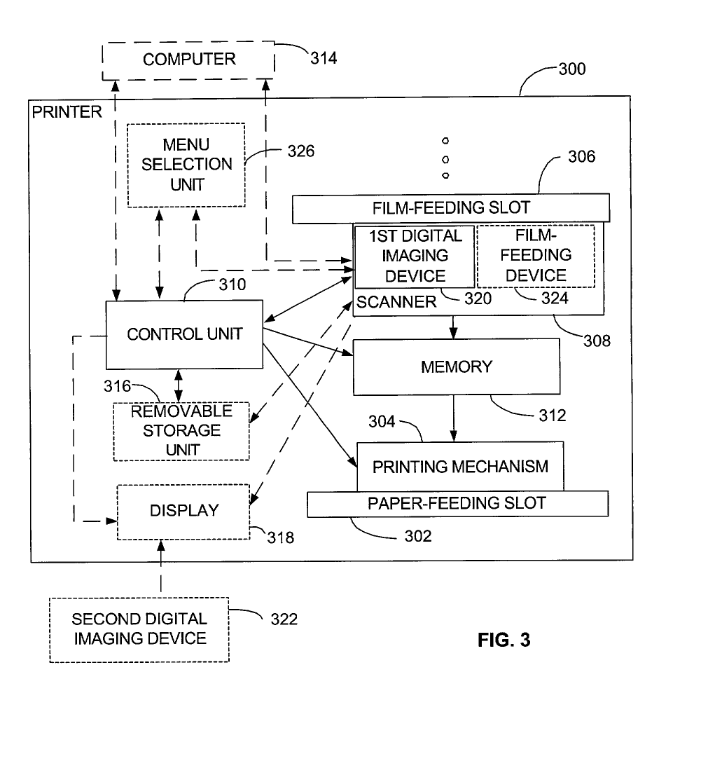

As shown in FIG. 3, the present invention may be implemented by a printer that, as well as printing output from a computer, provides for printing images directly from a film. The printer 300 has at least one paper-feeding slot 302 that is arranged to allow paper to feed into a printing mechanism 304 of the printer 300 and at least one film-feeding slot 306 that is arranged to feed film into a scanner 308. In a preferred embodiment, the scanner 308 generally includes a digital imaging device 320, 420 such as a Charge-Coupled Device (CCD) or Complementary Metal-Oxide Semiconductor (CMOS) sensor as is used in a digital still camera. The scanner 308 is coupled to a control unit 310. The scanner 308 scans at least one image from the film and stores at least one image in a memory 312. The memory 312 is coupled to the scanner 308 and to the control unit 310 and is used for storing the at least one image that is scanned. The printing mechanism 304 is coupled to the control unit 310. The printing mechanism 304 receives paper from the paper-feeding slot 302 and prints the at least one image that is scanned. The control unit 310 is coupled to the printing mechanism 304, the memory 312, and the scanner 308. The control unit 310, when activated by a user, initiates feeding of the paper into the printing mechanism 304 and the film into the scanner 308 in a predetermined fashion. In response to user input, the control unit 310 causes the scanner 308 to scan a selected portion of the film to provide the at least one image and store the at least one image in the memory 312. Then the printing mechanism 304 prints the at least one image on the paper. The at least one image for the at least one print may be selected by the user from a menu of images available on the film. Typically, the menu further provides for selection, by the user, of a designation, such as a letter or number, which may be used to indicate each image of the film that is desired to be printed. Also, a user may be allowed to select, using the menu, a desired number of prints and/or size of each selected image.

The film-feeding slot 306 may be one of a plurality of film slots and may be a slot arranged to accommodate, for example, a film strip for 35 mm film or a slide for 35 mm film. Again, the printer 300 may typically accommodate film with either a negative or positive image.

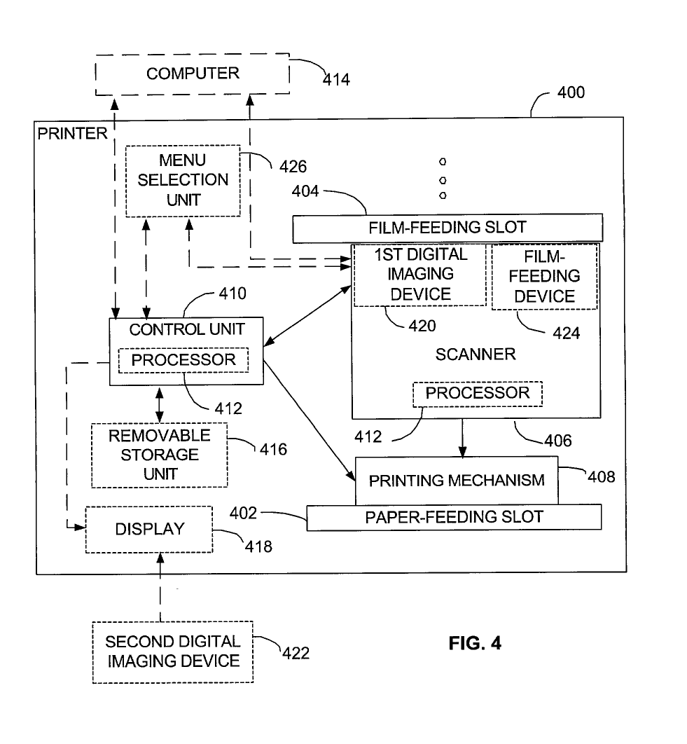

As shown in FIG. 4, the present invention may be implemented as a printer 400 for, as well as printing output from a computer, printing images directly from a film, wherein the printer 400 includes at least one paper-feeding slot 402, at least one film-feeding slot 404, a scanner 406, a printing mechanism 408 and a control unit 410. The at least one paper-feeding slot 402 allows paper to feed into the printing mechanism 408 of the printer 400. There is at least one film-feeding slot 404 that is arranged to feed film into the scanner 406. The scanner 406 is coupled to a control unit 410 to facilitate the user's initiation of operation of the scanner so that at least one image from the film may be scanned. The printing mechanism 408 is coupled to the control unit 410. Where desired, the control unit 410 may include a menu so that the user may select the size of the print desired and the number of prints to be printed. When the printing mechanism 408 receives paper from the paper-feeding slot 402, and the user has selected the portion of the film to be printed, the printing mechanism 408 prints the at least one image from the film. The control unit 410 is coupled to the printing mechanism 408 and the scanner 406, thus allowing the user to initiate feeding of the paper into the printing mechanism 408 and the film into the scanner 406 in a predetermined fashion. In response to the user's input to the control unit 410, the scanner scans a selected portion of the film to provide the at least one image and sends the at least one image to the printing mechanism 408. As is known in the art, the scanner 406 and/or control unit 410 may include a processor 412 that utilizes a predetermined scheme that permits real-time direct printing of the scanned image. The printing mechanism 408 then prints the at least one image on the paper.

The control unit 408 typically has, for example, for 35 mm film, a menu that allows the user to select at least one image for printing. For example, the designation of each image of the film may be indicated by a number or a letter that may be selected by the user to indicate which image is to be printed.

The printer 300, 400 may be arranged to provide many types of functionalities, as desired. For example, the scanned image may be uploaded to a computer 314, 414 for storage and further use or may be uploaded to a removable storage unit 316, 416 that is built into the printer such as a flash memory card or a writable compact disc (CD), for example. The computer 314, 414 may be coupled to the control unit 310, 410 and/or coupled to the scanner 308, 406 to implement this functionality.

Where desired, the control unit 310 or the processor 412 may be programmed to provide a “one button press” procedure that may be used to provide for scanning the film and printing the image.

Also, a display 318, 418 may be provided at the printer 300, 400 to allow the user to preview the image before actuating the printing process. In another embodiment, the display 318, 418 may be coupled to a digital imaging device 322, 422 to show live pictures being captured by the digital imaging device 322, 422, e.g., a CCD, so that the user can see the images in real time on the negative or positive film as they are passed over the digital imaging device 322, 422, also enabling the user to see the various pictures and center the images before printing. When scanning or capturing the image of negative film, the image is typically processed into a positive image for display.

In addition, the printer 300, 400 may include capability in the control unit 310, 410 or the processor 412 for zooming and cropping the image before printing in order to print a desired region.

The film-feeding slot 306, 404 may be coupled to a film-feeding device 324, 424 that passes a film strip over the scanner 308, 406. A menu selection unit 326, 426, coupled to the control unit 310, 410 may allow the user to direct the scanner 308, 406 to scan a particular one, some, or all of the pictures on the film strip. The menu selection unit 326, 426 may also be used to signal the control unit 310, 410 or the processor 412 for “red eye” removal on the image before printing the image.

Where desired, the menu selection unit 326, 426 may also provide for the user to select a desired number of prints of each selected image and/or the desired size of the image to be printed, which may generally be chosen from a plurality of output image sizes. Also, the menu selection unit 326, 426 may be used to select printing of multiple images per printed page.

The film-feeding slot may be one of a plurality of film slots such as, for example, a slot arranged to accommodate a film strip for 35 mm film or a slot arranged to accommodate a slide for 35 mm film. The film may provide a negative image or a positive image.

Thus, methods and printers have been described according to the present invention. Many modifications and variations may be made to the techniques and structures described and illustrated herein without departing from the spirit and scope of the invention. Accordingly, it should be understood that the methods and printers described herein are illustrative only and are not limiting upon the scope of the invention.

What is claimed is:

1. A method for printing an image directly from a film using a printer, where the printer may also function as a printer for a computer, comprising the steps of:
inserting the film into a film slot of the printer;
scanning at least one selected digital image from the film;
storing the at least one digital image that was scanned in memory; and
printing the at least one digital image.

2. The method of claim 1 wherein the at least one selected digital image is selected from a menu of images available on the film.

3. The method of claim 2 wherein the menu includes selection of a number of each digital image of the film that is desired to be printed.

4. The method of claim 2 wherein the menu provides for selection of a desired number of prints of each selected digital image.

5. The method of claim 1 wherein a size of the digital image printed is selectable at the printer from a plurality of output image sizes.

6. The method of claim 1 wherein the film slot is one of a plurality of film slots.

7. The method of claim 6 wherein one of the plurality of film slots is a slot arranged to accommodate a film strip for 35 mm film.

8. The method of claim 6 wherein one of the plurality of film slots is a slot arranged to accommodate a slide for 35 mm film.

9. The method of claim 1 wherein the film is one of: a film with a negative image and a film with a positive image.

10. A method for using a printer to provide at least one print from a film, where the printer may also function as a printer for a computer, comprising the steps of:
scanning a desired portion of the film in the printer to provide a digital image; and
printing the digital image.

11. The method of claim 10 wherein a digital image for the at least one print is selected from a menu of images available on the film.

12. The method of claim 11 wherein the menu further includes selection of a designation of each digital image of the film that is desired to be printed.

13. The method of claim 11 wherein the menu provides for selection of a desired number of prints of each selected digital image.

14. The method of claim 11 wherein a size of the digital image printed is selectable at the printer from a plurality of output image sizes.

15. The method of claim 11 wherein the film slot is one of a plurality of film slots.

16. The method of claim 15 wherein one of the plurality of film slots is a slot arranged to accommodate a film strip for 35 mm film.

17. The method of claim 15 wherein one of the plurality of film slots is a slot arranged to accommodate a slide for 35 mm film.

18. The method of claim 11 wherein the film is one of: a film with a negative image and a film with a positive image.

19. A printer for, as well as printing output from a computer, printing images directly from a film, comprising:
at least one paper-feeding slot, arranged to allow paper to feed into a printing mechanism of the printer;
at least one film-feeding slot, arranged to feed film into a scanner;
the scanner, coupled to a control unit, for scanning at least one image from the film and storing at least one image in a memory;
the memory, coupled to the scanner and to the control unit, for storing the at least one image that is scanned;
the printing mechanism, coupled to the control unit and arranged to receive paper from the paper-feeding slot, for printing the at least one image that is scanned; and
the control unit, coupled to the printing mechanism, the memory, the scanner and arranged to initiate feeding of the paper into the printing mechanism and the film into the scanner in a predetermined fashion, for, in response to user input, causing the scanner to scan a selected portion of the film to provide the at least one image, store the at least one image in the memory and print the at least one image on the paper.

20. The printer of claim 19 further including a menu selection unit, coupled to the control unit and the scanner, wherein the at least one image for the at least one print is selectable by the user from a menu of images available on the film.

21. The printer of claim 20 wherein the menu selection unit further provides for selection, by the user, of a designation of each image of the film that is desired to be printed.

22. The printer of claim 20 wherein the menu selection unit provides for the user to select a desired number of prints of each selected image.

23. The printer of claim 20 wherein the menu selection unit provides for selection of a print size of the image to be printed from a plurality of output image sizes.

24. The printer of claim 19 wherein the film-feeding slot is one of a plurality of film slots.

25. The printer of claim 24 wherein one of the plurality of film-feeding slots is a slot arranged to accommodate a film strip for 35 mm film.

26. The printer of claim 24 wherein one of the plurality of film-feeding slots is a slot arranged to accommodate a slide for 35 mm film.

27. The printer of claim 19 wherein the film is one of: a film with a negative image and a film with a positive image.

28. The printer of claim 19 wherein the computer is coupled to at least one of the control unit and the scanner, for uploading scanned images to the computer for storage.

29. The printer of claim 19 wherein the scanner includes a first digital imaging device.

30. The printer of claim 29 wherein the first digital imaging device is one of: a charge-coupled device and a complementary metal-oxide semiconductor.

31. The printer of claim 19 wherein the printer includes a removable storage unit, removably coupled to the control unit and the scanner, for storing the at least one image in the removable storage unit.

32. The printer of claim 31 wherein the removable storage unit is one of a flash memory card and a writable compact disc.

33. The printer of claim 19 wherein the printer includes a display, coupled to the control unit and the scanner, for displaying the at least one image.

34. The printer of claim 33 wherein the display is further coupled to a second digital imaging device to show live pictures being captured by the second digital imaging device and to allow the user to center the at least one image before printing.

35. The printer of claim 19 wherein the menu selection unit further provides for selection of at least one of: zooming in, zooming out, cropping, removing “red eye” from the image and directing scanning of a selected plurality of images.

36. The printer of claim 19 wherein the at least one film feeding slot is coupled to a film-feeding device that passes film over the scanner.

37. A printer for, as well as printing output from a computer, printing images directly from a film, comprising:
at least one paper-feeding slot, arranged to allow paper to feed into a printing mechanism of the printer;
at least one film-feeding slot, arranged to feed film into a scanner;
the scanner, coupled to a control unit, for scanning at least one image from the film;
the printing mechanism, coupled to the control unit and arranged to receive paper from the paper-feeding slot, for printing the at least one image from the film; and
the control unit, coupled to the printing mechanism and the scanner and arranged to initiate feeding of the paper into the printing mechanism and the film into the scanner in a predetermined fashion, for, in response to user input, causing the scanner to scan a selected portion of the film to provide the at least one image and send the at least one image to the printing mechanism and the printing mechanism to print the at least one image on the paper.

38. The printer of claim 37 further including a menu selection unit, coupled to the control unit and the scanner, wherein the at least one image for the at least one print is selectable by the user from a menu of images available on the film.

39. The printer of claim 38 wherein the menu selection unit further provides for selection, by the user, of a designation of each image of the film that is desired to be printed.

40. The printer of claim 38 wherein the menu selection unit provides for the user to select a desired number of prints of each selected image.

41. The printer of claim 38 wherein the menu selection unit provides for selection of a print size of the image to be printed from a plurality of output image sizes.

42. The printer of claim 37 wherein the film-feeding slot is one of a plurality of film slots.

43. The printer of claim 42 wherein one of the plurality of film-feeding slots is a slot arranged to accommodate a film strip for 35 mm film.

44. The printer of claim 42 wherein one of the plurality of film-feeding slots is a slot arranged to accommodate a slide for 35 mm film.

45. The printer of claim 37 wherein the film is one of: a film with a negative image and a film with a positive image.

46. The printer of claim 37 wherein the computer is coupled to at least one of the control unit and the scanner, for uploading scanned images to the computer for storage.

47. The printer of claim 37 wherein the scanner includes a first digital imaging device.

48. The printer of claim 47 wherein the first digital imaging device is one of: a charge-coupled device and a complementary metal-oxide semiconductor.

49. The printer of claim 37 wherein the printer includes a removable storage unit, removably coupled to the control unit and the scanner, for storing the at least one image in the removable storage unit.

50. The printer of claim 49 wherein the removable storage unit is one of a flash memory card and a writable compact disc.

51. The printer of claim 37 wherein the printer includes a display, coupled to the control unit and the scanner, for displaying the at least one image.

52. The printer of claim 51 wherein the display is further coupled to a second digital imaging device to show live pictures being captured by the second digital imaging device and to allow the user to center the at least one image before printing.

53. The printer of claim 38 wherein the menu selection unit further provides for selection of at least one of: zooming in, zooming out, cropping, removing “red eye” from the image and directing scanning of a selected plurality of images.

54. The printer of claim 37 wherein the at least one film feeding slot is coupled to a film-feeding device that passes film over the scanner.

55. The printer of claim 37 wherein the control unit includes a processor programmed with a predetermined scheme that sends scanned information to the printing mechanism for printing without intermediate storage of the scanned information.

56. The printer of claim 37 wherein the scanner includes a processor programmed with a predetermined scheme that sends scanned information to the printing mechanism for printing without intermediate storage of the scanned information.
